(19) United States
(12) Patent Application Publication
(10) Pub. No.: US 2016/0197565 A1
(43) Pub. Date: Jul. 7, 2016

(54) Procedure for the monitoring of drive motors

(71) Applicant: KSL FIBERTEC GMBH, Isny (DE)

(72) Inventor: Karl Michael Kaeser, Isny (DE)

(21) Appl. No.: 14/786,973

(22) PCT Filed: Apr. 22, 2014
(86) PCT No.: PCT/DE2014/200175

§ 371 Date: Feb. 12, 2016

(30) Foreign Application Priority Data
Apr. 24, 2013 (DE) 10 2013 104 164.7

(51) Int. Cl. H02P 1/02; B64D 45/00; A63H 29/22; B64D 27/24; H02P 6/20; H02P 29/02

(52) U.S. Cl. CPC H02P 1/022; H02P 6/20; H02P 29/02; A63H 29/22; B64D 27/24; B64D 45/00

(57) ABSTRACT

The invention relates to a method for monitoring drive engines, particularly for aircraft or the like, particularly in the start-up phase, wherein a detection of abnormal start-up behavior, particularly elevated torque, is provided, or the drive units are held at a resting rotational speed during standby and are not completely stopped, and/or warning signs are provided during the standby.

### CROSS REFERENCE TO RELATED APPLICATIONS

This application claims the benefit of priority to the International (PCT) application filed on Apr. 22, 2014, having International Application No. PCT/DE2014/200175, as well as the German Application filed on Apr. 24, 2013, having application no. 10 2013 104 164.7, both of which are incorporated herein by reference:

### BACKGROUND OF THE INVENTION

The invention relates to a method for monitoring drive motors, particularly for aircraft or the like, particularly in the start-up phase.

Airplanes driven by electric motors have the issue that their propellers may accidentally start turning when they are in standby operating mode. This often leads to damage or even injury.

The object of the invention is to avoid this damage.

### SUMMARY OF THE INVENTION

The objects of the invention are achieved by a method for operating an electric motor for the propulsion of an aircraft, the method comprising the ability to detect abnormal start-up behavior.

Other objects are achieved by the above method wherein the ability to detect abnormal start-up behavior is realized by detection of an increased torque.

Other objects are achieved by any of the above methods further comprising that a blocking propeller driven by the electric motor can be detected.

Other objects are achieved by any of the above methods further comprising that a worn bearing can be detected.

Other objects are achieved by any of the above methods further comprising that while the electric motor is started up at a low rotational speed, the deviation of desired rotation to the actual rotation respectively desired torque to actual torque is determined and evaluated.

Other objects are achieved by any of the above methods further comprising the electric motor is shut down in case the deviation of the actual from the desired value is above a threshold value.

Other objects are achieved by any of the above methods further comprising that the detection is adapted to the moment of inertia of the propeller and the electric motor.

Other objects are achieved by any of the above methods further comprising that while the stator of the electric motor is supplied with a slowly rotating electric field and so the rotor is pulled along, the relative position of the rotor with respect to the field is determined.

Other objects are achieved by any of the above methods wherein a suitable sensor is used to determine the position of the rotor.

Other objects are achieved by any of the above methods wherein the sensor is an encoder.

Other objects are achieved by any of the above methods further comprising that external forces acting on a propeller and thus on the electric motor can be detected.

Other objects are achieved by any of the above methods further comprising that a lead of the rotor can be identified by the actual rotational speed being higher than the desired rotational speed and/or the actual torque being lower than the desired torque or even negative.

Other objects are achieved by any of the above methods further comprising that an at the beginning halted propeller is slowly turned by an electric motor and the start-up of the electric motor is aborted when a torque acting against the propeller rotation exceeds a threshold value.

Other objects are achieved by any of the above methods further comprising that after the abort of the start-up of the electric motor the propulsion is blocked until it is unlocked manually.

### DETAILED DESCRIPTION

The invention accomplishes this aspect by keeping the drive units moving at an idling rotational speed, not halting completely, while in standby operating mode and/or by issuing warning signals in standby operating mode.

Thus, the standby operating mode of the drive motors is easily recognized. Even at a low rotational speed the rotation usually causes enough noise to be very well perceived. Another option to provide warning functionality are warning signs, i.e. audible warning sounds, artificial engine noise, light signals.

Especially new aircraft types in aviation, mainly airplanes, airships, concepts such as e-volo, quadrocopter and multicopter but also models, here mainly toy aircraft use changed motor and propeller arrangements.

Until now, it was quite common that due to their mass and due to the balance of the center of gravity of the aircraft the drives have been in the view of the pilot.

This is no longer given, with the new configurations. Due to the reduced weight of the new drives, there are some configurations with propellers behind the wings of an airplane.

In order to prevent damage to the drive, e.g. via hitting objects with the propeller blades but also to prevent people being hit by starting propellers a process to eliminate this problem needs to be found.

In addition, another aspect of the invention is to detect defects in the drive motors as early as possible.

The invention accomplishes this object with providing detection of abnormal start-up behavior, mainly for increased torque.

Hereby the start-up phase can be monitored. With considering the power of impact of the propeller due to the drive train rotational energy, the start-up phase can be shaped such that the maximal possible positive rotational speed gradient without danger of injuries is achieved.

According to one aspect of the invention it is very advantageous to provide a detection strategy which is able to detect a blocking propeller and/or worn bearings.

This prevents damages.

Another aspect of the invention is that the motor is started up at a low rotational speed; the deviation of desired rotation to the actual rotation respectively desired torque to actual torque of the motor is determined and evaluated.

Should any object be in the range of the motor, damage to the drive, to the object and injuries will be prevented due to the low rotational speed.

Another aspect of the invention is that the respective detection is matched to the respective torque of inertia of the drive train.

Thus, the influence of the mass from the moving parts of the drive in the monitoring of the drive is taken into account.

An embodiment of the invention is using one or several electric motors for the drive.

Especially for low noise electric motors, which are able to rapidly accelerate a propeller, damage and injury are possible. In addition, an indefinite time may pass between switching on, i.e. turning on the current feed for the power electronics, and commanding start-up of the motor. This problem has in several cases caused injuries and damages, especially with toy airplanes, because it was forgotten that the power electronics was in standby.

An aspect of the invention is that while the stator of the electric motor is supplied with a slowly rotating electric field and so the rotor is entrained, the relative position of the rotor with respect to the field is determined.

Thereby blockades and stiffness can be detected.

A further aspect is that a suitable sensor is used for detecting the position of the rotor, preferably an encoder.

Thereby the position of the rotor can be determined precisely at any time and compared to the rotating field.

In an embodiment a torque controller and/or detector is used.

By using a torque controller the demanded torque can be easily determined. Problems can be recognized. Torque magnitude may be gathered from current consumption.

In an embodiment a rotational speed controller and/or detector is used.

A problem is present as soon as the actual rotational speed lags behind the commanded rotational speed more than a threshold value. The rotational speed can be determined for example by measuring the induced current in the unpowered coils.

In an embodiment a position controller and/or detector is used.

Thereby deviations of expected and actual position of the rotor can be determined. Problems can be detected.

In an embodiment too high deviation of actual value to target value for each controlled parameter leads to detection of the deviation.

Thereby problems can be detected at an early stage. The drive can be shut-down automatically or manually.

An embodiment is that the threshold values for the deviations are set in advance or determined by the operation conditions.

Predetermined threshold values are very easy to handle. Integrating certain operation conditions in the computation of the threshold values can under certain conditions improve the accuracy of detection.

Below is a description of several embodiments' examples of the invention.

The embodiment examples refer to electrical motors for aircraft, but they can be transferred to other motors and motor types. Above all, the use in the field of toy aircraft is conceivable. The basic consideration of all embodiment examples is that an at the beginning halted propeller is slowly turned by the motor. An obstacle in the disk area leads to a torque acting on the propeller.

The torque shall be detected. If the torque value is higher than a threshold, the start-up shall be aborted.

The threshold value depends on the configuration of the drive train. It can be either predetermined or influenced and changed under certain environment conditions. E.g. at a high wind velocity the threshold value is set higher than at a low wind velocity.

As a subsidiary to a negative torque detection, a stiffness of the drive e.g. by a worn bearing can be detected.

If an exceedance of the threshold is detected, the start-up phase will be aborted and the motor can be blocked so that it has to be unlocked manually.

An essential part of these methods of detection is that the maximal rotational speed is limited, thereby it is ensured that firstly the motor will not be damaged when there is a blocking and secondly that in case of aborting the start-up phase there will be no unfavorably stress.

A side effect is that at low speeds the aerodynamic counter torque created by the propeller is insignificant and therefore it is easier to recognize obstacles.

In BLDC (brushless DC motor) and PMAC (permanent magnet AC motor) motors, the stator can be energized by a constant, slowly rotating electric field.

This field is directed in the negative d-axis within the rotating dq0 (direct-quadrature-zero transformation) coordinate system.

With a precise alignment consequently no torque acts on the rotor.

By rotating the field the rotor is pulled along.

With this technique a slow rotation of the rotor can be realized even while using a slow controller.

For this purpose the externally determined vector controlled inverters, which are often used in highly efficient PMAC motors, can be used.

Applying a forced rotating electric field is also possible for BLDC motors.

With a position sensor, e.g. an encoder can be used, the position of the rotor can be determined and in case of a too high deviation of the expected position the abortion can be triggered.

An alternative is to compare the mean rotational speed of the rotor with the angular velocity of the field and in case of a too high deviation the abortion can be triggered. The applied field has to be strong enough to entrain the rotor under all circumstances.

The field has to be sufficiently strong in case airflow is acting on the propeller. In addition the thresholds should be increased, to prevent a faulty obstacle detection leading to an erroneous safety shutdown.

Since there is always friction in the drive system, the rotor will allays lag behind the rotating electrical field. The thereby occurring stick-slip effect has to be considered in choosing the thresholds. An averaging of the measured values can be advantageous.

However it is conceivable that at DC, BLDC and PMAC motors a torque control is used superimposed with a rotational speed control.

At the start-up phase a low target rotational speed is commanded.

A too high torque requested by the rotational speed controller can be used as an abort criterion.

In combination or alternatively, the maximal torque available to the rotational speed controller can be limited by a saturation element. Then the abortion is carried out in case the deviation of desired and actual rotational speed is too high.

In this context it is conceivable that the detection of the torque is limited to positive values at the input of the torque controller.

If negative values occur, the propeller is driven externally by so-called wind milling. In this case the propeller can rotate through the restriction to positive torque values freely, without being slowed down by the rotational speed controller. Thereby an “In flight detection” can be implemented.

With using BLDC and PMAC motors for this embodiment, an absolute angle encoder or an initialization are required to be able to adapt the electronic commutation.

In a modification of this embodiment example, in addition to the rotational speed control a position control can be superimposed.

This allows to set a target position for the rotor angle. The target position is rotated continuously.

Thereby a too high deviation between the target position and actual position can be used as an additional abort condition.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A method for operating an electric motor for the propulsion of an aircraft, the method comprising the ability to detect abnormal start-up behavior.

2. The method of claim 1 wherein the ability to detect abnormal start-up behavior is realized by detection of an increased torque.

3. The method of claim 2 further comprising that a blocking propeller driven by the electric motor can be detected.

4. The method of claim 2 further comprising that a worn bearing can be detected.

5. The method of claim 2 further comprising that while the electric motor is started up at a low rotational speed, the deviation of desired rotation to the actual rotation respectively desired torque to actual torque is determined and evaluated.

6. The method of claim 5 further comprising the electric motor is shut down in case the deviation of the actual from the desired value is above a threshold value.

7. The method of claim 2 further comprising that the detection is adapted to the moment of inertia of the propeller and the electric motor.

8. The method of claim 2 further comprising that while the stator of the electric motor is supplied with a slowly rotating electric field and so the rotor is pulled along, the relative position of the rotor with respect to the field is determined.

9. The method of claim 8 wherein a suitable sensor is used to determine the position of the rotor.

10. The method of claim 9 wherein the sensor is an encoder.

11. The method of claim 2 further comprising that external forces acting on a propeller and thus on the electric motor can be detected.

12. The method of claim 11 further comprising that a lead of the rotor can be identified by the actual rotational speed being higher than the desired rotational speed and/or the actual torque being lower than the desired torque or even negative.

13. The method of claim 2 further comprising that an at the beginning halted propeller is slowly turned by an electric motor and the start-up of the electric motor is aborted when a torque acting against the propeller rotation exceeds a threshold value.

14. The method of claim 13 further comprising that after the abort of the start-up of the electric motor the propulsion is blocked until it is unlocked manually.

15. A method for operating an electric motor for the propulsion of an aircraft, the method comprising the steps of:
a. energizing the electric motor to rotate at a first low rotational speed, the low rotational speed being lower than a second rotational speed need to propel the aircraft,
b. measuring the torque at the first low rotational speed,
c. comparing the torque at the low rotational speed to a predetermined desired torque characteristic of normal operation,
d. when the torque measured in step c exceeds the pre-determined torque, de-energizing the motor,
e. when the torque measured in step c does not exceed the pre-determined torque further energizing the electric motor to rotate at the second rotational speed.

16. The method of operating an electric motor for the propulsion of an aircraft according claim 15 wherein the torque in step b is measure by motor power consumption.

17. A method for operating an electric motor for the propulsion of an aircraft, the method comprising the steps of:
a. energizing the electric motor to rotate at a first low rotational speed by supplying a stator of the motor with a slowly rotating electric field so a rotor of the electric motor is pulled along , wherein the level of energizing of the electric motor results in a low rotational speed being lower than a second rotational speed needed to propel the aircraft,
b. determining the relative position of the rotor with respect to the slowly rotating electric field,
d. when the relative position of the rotor with respect to the slowly rotating electric field determined in step b differs from a pre-determined relative position then de-energizing the motor.
e. when the relative position of the rotor with respect to the slowly rotating electric field determined in step b does not differ from a pre-determined relative position further energizing the electric motor to rotate at the second rotational speed.

18. The method for operating an electric motor for the propulsion of an aircraft according to one of claims 15 further comprising the step of blocking further energizing of the electric motor upon being de-energized until it is manually unblocked.

19. The method of operating an electric motor for the propulsion of an aircraft according claim 12 wherein the speed is determined from secondary streams in de-energized windings.

20. The method for operating an electric motor for the propulsion of an aircraft according to one of claims 17 further comprising the step of blocking further energizing of the electric motor upon being de-energized until it is manually unblocked.
